(19) United States
(12) Patent Application Publication
(10) Pub. No.: US 2014/0168501 A1
(43) Pub. Date: Jun. 19, 2014

(54) ZOOM LENS AND IMAGING APPARATUS

(71) Applicant: Sony Corporation, Tokyo (JP)

(72) Inventor: Koji Toyoda, Kanagawa (JP)

(73) Assignee: Sony Corporation, Tokyo (JP)

(21) Appl. No.: 14/105,886

(22) Filed: Dec. 13, 2013

(30) Foreign Application Priority Data
Dec. 19, 2012 (JP) 2012-276949

(51) Int. Cl. G02B 13/00; H04N 5/225

(52) U.S. Cl. CPC G02B 13/009; H04N 5/2254
USPC 348/345; 359/687

(57) ABSTRACT

There is provided a zoom lens including, in order from an object side: a first lens group having a positive refractive power; a second lens group having a negative refractive power; a third lens group having a positive refractive power; and a fourth lens group having a positive refractive power. The second lens group includes, in order from an object side, a negative meniscus lens concave toward an image plane side, a negative lens concave toward both sides, and a positive lens convex toward both sides. The negative lens and the positive lens of the second lens group are made of a resin material, and satisfy the following Conditional Expression (a). Conditional Expression (a): 1.02<Nd23/Nd22<1.10. Here, Nd22 is a d-line refractive index of the negative lens of the second lens group, and Nd23 is a d-line refractive index of the positive lens of the second lens group.

### CROSS REFERENCE TO RELATED APPLICATIONS

This application claims the benefit of Japanese Priority Patent Application JP 2012-276949 filed Dec. 19, 2012, the entire contents of which are incorporated herein by reference.

### BACKGROUND

The present technology relates to a zoom lens and an imaging apparatus. Specifically, the present technology relates to a zoom lens, which is appropriate for an imaging lens system used in small-size imaging apparatuses such as a digital still camera and a home video camera, and an imaging apparatus using the zoom lens.

In recent years, imaging apparatuses using solid-state imaging devices such as a digital still camera have come into widespread use. As such digital still cameras and the like have come into widespread use, there has been an increase in the demand for higher image quality. In particularly, in the digital still cameras with a large number of pixels and the like, there is a demand for a photographing lens which exhibits excellent imaging performance for a solid-state imaging device with a large number of pixels, particularly, a zoom lens. Further, recently, there have been increases in the demands for a decrease in the size, an increase in the angle of view, and an increase in the magnification of the zoom ratio. Thus, there has been a demand for a zoom lens capable of coping with all the demands. Furthermore, in terms of the decrease in the size, there have been demands not only for a decrease in the size such as the front lens diameter or the entire optical length at the time of photography, but also for a decrease in the size in a state where the lens groups are housed in a camera main body, that is, a so-called collapsed state, simultaneously.

Meanwhile, in addition to the above-mentioned various demands, there has been a recent demand for a decrease in the weight of the imaging apparatus. Further, the decrease in the weight enhances the operability and portability of the imaging apparatus. To this end, by further decreasing the weight of the lens, it is possible to realize a zoom lens which has a small size, is highly functional, and has a lower weight. There are various types of zoom lenses used in the digital still camera and the like, but particularly in the related art, as a type of a lens appropriate for a decrease in the size and an increase in the magnification, there is a zoom lens having four lens groups formed by the following combination. That is, the zoom lens includes, in order from the object side, a first lens group having a positive refractive power, a second lens group having a negative refractive power, a third lens group having a positive refractive power, and a fourth lens group having a positive refractive power (for example, refer to Japanese Unexamined Patent Application Publication No. 2009-186983).

### SUMMARY

In the above-mentioned related art, the second lens group includes, in order from an object side, a negative lens, and a cemented lens of a positive lens and a negative lens, and all the lenses are made of a glass material. However, with such a configuration, the weight of the imaging apparatus is increased by the weight of the glass material, and this has an effect on the portability thereof. Further, due to movement of the second lens group performed by zooming or extension at the time of photography, the barycenter position is changed, and this change has influence on the operability of the photography.

Furthermore, when two lenses on the image side in the second lens group are formed as a cemented lens, due to restriction in aberration correction depending on a decrease in the degree of freedom in design, an increase in the refractive power of the second lens group is restricted. As a result, the zoom lens is not appropriate for a decrease in the size and an increase in the magnification. In addition, the first lens group includes, in order from an object side, a negative meniscus lens and a biconvex positive lens, and all the lenses are made of a glass material. However, with such a configuration, particularly the center thickness of the biconvex positive lens becomes quite large in order to secure the edge thickness thereof. Thereby, the weight of the biconvex positive lens becomes quite high, and this change has influence on the portability and the operability.

It is desirable to realize a zoom lens and an imaging apparatus which have high imaging performance, a sufficient angle of view at the wide-angle end, and a sufficient zoom ratio, and of which the entire optical length is short, the front lens diameter is small, the size is small even in the collapsed state, and the portability and operability are good with a light weight.

According to a first embodiment of the present technology, there is provided a zoom lens including, in order from an object side: a first lens group having a positive refractive power; a second lens group having a negative refractive power; a third lens group having a positive refractive power; and a fourth lens group having a positive refractive power, in which the second lens group includes, in order from an object side, a negative meniscus lens concave toward an image plane side, a negative lens concave toward both sides, and a positive lens convex toward both sides, and in which the negative lens and the positive lens of the second lens group are made of a resin material, and satisfy the following Conditional Expression (a). Conditional Expression (a): 1.02<Nd23/Nd22<1.10, where Nd22 is a d-line refractive index of the negative lens of the second lens group, and Nd23 is a d-line refractive index of the positive lens of the second lens group. Thereby, this configuration has an effect to decrease the weights of the negative lens and the positive lens of the second lens group.

In the first embodiment, the following Conditional Expressions (b) and (c) may be satisfied. Conditional Expression (b): 52<νd22<60, and Conditional Expression (c): 20<νd23<31, where νd22 is an Abbe number of the negative lens of the second lens group, and νd23 is an Abbe number of the positive lens of the second lens group.

In the first embodiment, during power variation from a wide-angle end to a telephoto end, each group may move to increase the spacing between the first lens group and the second lens group and decrease the spacing between the second lens group and the third lens group.

In the first embodiment, the following Conditional Expression (d) may be satisfied. Conditional Expression (d): −1.08<F22/F23<−0.82, where F22 is a focal length of the negative lens of the second lens group and F23 is a focal length of the positive lens of the second lens group.

In the first embodiment, the following Conditional Expression (e) may be satisfied. Conditional Expression (e): 0.34<FW/F23<0.60, where F23 is a focal length of the positive lens of the second lens group, and FW is a focal length of the zoom lens at the wide-angle end.

In the first embodiment, the following Conditional Expression (f) may be satisfied. Conditional Expression (f): −0.88<FW/F2<−0.66, where FW is a focal length of the zoom lens at the wide-angle end, and F2 is a focal length of the second lens group.

In the first embodiment, at least one surface of the negative lens of the second lens group may be aspheric. Further, at least one surface of the positive lens of the second lens group may be aspheric.

In the first embodiment, the first lens group includes a cemented lens formed of a negative meniscus lens convex toward the object side and a positive meniscus lens convex toward the object side, and satisfies the following Conditional Expressions (g), (h), and (i). Conditional Expression (g): 2.5<D12/D11<3.1, Conditional Expression (h): 1.72<Nd12<1.82, and Conditional Expression (i): 0.41<(D11+D12)/FW<0.51, where D11 is an on-axis center thickness of the negative meniscus lens of the first lens group, D12 is an on-axis center thickness of the positive meniscus lens of the first lens group, and Nd12 is a d-line refractive index of the positive meniscus lens of the first lens group.

According to a second embodiment of the present technology, there is provided an imaging apparatus including: a zoom lens; and an imaging device that converts an optical image, which is formed by the zoom lens, into an electric signal, in which the zoom lens includes, in order from an object side, a first lens group having a positive refractive power, a second lens group having a negative refractive power, a third lens group having a positive refractive power, and a fourth lens group having a positive refractive power, in which the second lens group includes, in order from an object side, a negative meniscus lens concave toward an image plane side, a negative lens concave toward both sides, and a positive lens convex toward both sides, and in which the negative lens and the positive lens of the second lens group are made of a resin material, and satisfy the following Conditional Expression (a). Conditional Expression (a): 1.02<Nd23/Nd22<1.10, where Nd22 is a d-line refractive index of the negative lens of the second lens group, and Nd23 is a d-line refractive index of the positive lens of the second lens group.

In this case, in the zoom lens having four lens groups, by decreasing the weight of the lens, it is possible to obtain an excellent effect of realizing a zoom lens and an imaging apparatus having good portability and operability.

### BRIEF DESCRIPTION OF THE DRAWINGS

FIG. 1 is a diagram illustrating a lens configuration of a zoom lens according to a first embodiment of the present technology;

FIGS. 2A to 2C are diagrams illustrating various aberrations in the wide-angle end state of the zoom lens according to the first embodiment of the present technology;

FIGS. 3A to 3C are diagrams illustrating various aberrations in the middle focal length state of the zoom lens according to the first embodiment of the present technology;

FIGS. 4A to 4C are diagrams illustrating various aberrations in the telephoto end state of the zoom lens according to the first embodiment of the present technology;

FIG. 5 is a diagram illustrating a lens configuration of a zoom lens according to a second embodiment of the present technology;

FIGS. 6A to 6C are diagrams illustrating various aberrations in the wide-angle end state of the zoom lens according to the second embodiment of the present technology;

FIGS. 7A to 7C are diagrams illustrating various aberrations in the middle focal length state of the zoom lens according to the second embodiment of the present technology;

FIGS. 8A to 8C are diagrams illustrating various aberrations in the telephoto end state of the zoom lens according to the second embodiment of the present technology;

FIG. 9 is a diagram illustrating a lens configuration of a zoom lens according to a third embodiment of the present technology;

FIGS. 10A to 10C are diagrams illustrating various aberrations in the wide-angle end state of the zoom lens according to the third embodiment of the present technology;

FIGS. 11A to 11C are diagrams illustrating various aberrations in the middle focal length state of the zoom lens according to the third embodiment of the present technology;

FIGS. 12A to 12C are diagrams illustrating various aberrations in the telephoto end state of the zoom lens according to the third embodiment of the present technology; and

FIG. 13 is a diagram illustrating an example in which the zoom lens according to the first to third embodiments of the present technology is applied to an imaging apparatus.

### DETAILED DESCRIPTION OF EMBODIMENTS

A zoom lens according to an embodiment of the present disclosure includes, in order from the object side on the optical axis, a first lens group GR1 having a positive refractive power, a second lens group GR2 having a negative refractive power, a third lens group GR3 having a positive refractive power, and a fourth lens group GR4 having a positive refractive power. During power variation from the wide-angle end to the telephoto end, each group moves to increase the spacing between the first lens group GR1 and the second lens group GR2 and decrease the spacing between the second lens group GR2 and the third lens group GR3.

The first lens group GR1 includes, in order from the object side, a cemented lens formed of a negative meniscus lens L11 convex toward the object side and a positive meniscus lens L12 convex toward the object side. The second lens group GR2 includes, in order from the object side, a negative meniscus lens L21 concave toward the image plane side, a negative lens L22 concave toward both sides, and a positive lens L23 convex toward both sides. The third lens group GR3 includes, in order from an object side, a positive lens L31 convex toward both sides and a negative meniscus lens L32 concave toward the image plane side. The fourth lens group GR4 includes a positive lens L41.

During power variation, the lateral magnification of the second lens group GR2 is changed by changing the spacing between the first lens group GR1 and the second lens group GR2. Further, during power variation, by changing the spacing between the second lens group GR2 and the third lens group GR3 mainly having a function of an imaging effect of the zoom lens, a degree of freedom in the power variation load of each group is increased. As a result, a high variable-power ratio is achieved with a small size. Furthermore, during power variation, by changing the spacing between the third lens group GR3 and the fourth lens group GR4, the power variation effect is generated by the fourth lens group GR4. As a result, it is possible to more decrease the size thereof, and it is also possible to effectively suppress the change in the image field curvature and the like caused by the power variation.

The first lens group GR1 includes, in order from an object side, two lenses of the negative meniscus lens L11 and the positive meniscus lens L12, whereby it is possible to thin the first lens group GR1 while suppressing the longitudinal chromatic aberration on the telephoto side. Further, when the first lens group GR1 can be formed to be thinned, the distance from the first lens group GR1 to the aperture diaphragm decreases, and consequently the distance between the first lens group GR1 and the entrance pupil decreases. Thereby, it is possible to achieve a wide angle while suppressing an increase in the front lens diameter. Furthermore, when the size of the front lens diameter is set to be small, the necessary edge thickness of the positive meniscus lens L12 of the first lens group GR1 further decreases. As a result, it is possible to decrease the thickness of the zoom lens more than that of a zoom lens in which the first lens group GR1 includes three or more lenses. The above-mentioned decrease in the size of the first lens group GR1 contributes to not only the decrease in the entire optical length and the decrease in the front lens diameter, but also the decrease in the size of the zoom lens at the time of collapse. If the first lens group GR1 includes three lenses, the entrance pupil becomes farther from the object side surface of the zoom lens. Thus, the front lens diameter increases.

The second lens group GR2 includes, in order from an object side, the negative meniscus lens L21, the negative lens L22 concave toward both sides, and the positive lens L23 convex toward both sides. By adopting the above-mentioned configuration in which the second lens group GR2 having a negative refractive power includes three lenses in the whole system, even in a high-power zoom lens of which the variable-power ratio is equal to or greater than 6 times and equal to or less than 15 times, it is possible to effectively suppress the lateral chromatic aberration and the image field curvature at the wide-angle end and the spherical aberration at the telephoto end.

The third lens group GR3 includes, in order from an object side, the positive lens L31 convex toward both sides and the negative meniscus lens L32 concave toward the image plane side. By adopting such arrangement, it is possible to satisfactorily correct the image field curvature and the spherical aberration in the entire range from the wide-angle end to the telephoto end. Further, when an aperture diaphragm is disposed on the object side of the third lens group GR3, the exit pupil position becomes farther from the image plane. As a result, it is possible to decrease an angle of incidence of rays onto the image pickup surface, and it is possible to reduce occurrence of erroneous color and deterioration in the light amount at the peripheral portion of the image pickup area. If the third lens group GR3 includes three or more lenses, it is difficult to decrease the center thickness of the third lens group GR3. As a result, this configuration is not appropriate for the decrease in the size in the collapsed state.

The fourth lens group GR4 is formed of a single positive lens, and corrects fluctuation in various aberrations and fluctuation in the imaging position at the time of power variation. Further, since the group is formed of a single lens with a small size, the zoom lens is lightweight, and is appropriate to be used in focusing at various object distances.

By adopting the above-mentioned lens configurations of the groups, in the zoom lens of which the magnification is equal to or greater than 6 times and equal to or less than 15 times, it is possible to appropriately correct various aberrations such as the spherical aberration, the image field curvature, and the distortion at each zoom range. Further, it is possible to decrease the entire optical length and the front lens diameter. Furthermore, with a configuration of a total of 8 lenses, it is possible to achieve the decrease in the size at the time of collapse.

Further, it is more preferable that the zoom lens according to the embodiment of the present disclosure satisfy the following Conditional Expression (a).

1.02<Nd23/Nd22<1.10 Conditional Expression (a):

Here, Nd22 is a d-line refractive index of the lens L22, and Nd23 is a d-line refractive index of the lens L23.

Conditional Expression (a) is a condition for using the resin material in the negative lens L22 and the positive lens L23 of the second lens group GR2. When the result is out of range of Conditional Expression (a), it is necessary to use a glass material in either one or both of the negative lens L22 and the positive lens L23. Hence, the weight of the zoom lens increases.

In addition, in the zoom lens according to an embodiment of the present disclosure, it is more preferable that the numerical range of Conditional Expression (a) be set as a range of the following Conditional Expression (a′).

1.03<Nd23/Nd22<1.09 Conditional Expression (a′):

Further, it is more preferable that the zoom lens according to the embodiment of the present disclosure satisfy the following Conditional Expressions (b) and (c).

52<νd22<60 Conditional Expression (b):

20<νd23<31 Conditional Expression (c):

Here, νd22 is an Abbe number of the lens L22, and νd23 is an Abbe number of the lens L23.

Conditional Expressions (b) and (c) are conditions for correcting various aberrations in the case where the resin material is used in the negative lens L22 and positive lens L23 of the second lens group GR2, particularly, for correcting the chromatic aberration. Conditional Expression (b) is a condition for constraining the negative lens L22. When the result is out of range of Conditional Expression (b), this has an effect on deterioration in the various aberrations, and particularly the chromatic aberration deteriorates. Further, when the result is out of the existing range for the resin material, it is thus necessary to use the glass material. As a result, the weight increases, and this configuration is not preferable. Conditional Expression (c) is a condition for constraining the positive lens L23. When the result is out of range of Conditional Expression (c), this configuration has an effect on deterioration in the various aberrations, and particularly the chromatic aberration deteriorates. Further, when the result is out of the existing range for the resin material, it is thus necessary to use the glass material. As a result, the weight increases.

In addition, in the zoom lens according to an embodiment of the present disclosure, it is more preferable that the numerical ranges of Conditional Expressions (b) and (c) be set as ranges of the following Conditional Expressions (b′) and (c′).

54<νd22<58 Conditional Expression (b′):

22<νd23<29 Conditional Expression (c′):

Further, it is more preferable that the zoom lens according to the embodiment of the present disclosure satisfy the following Conditional Expression (d).

−1.08<F22/F23<−0.82 Conditional Expression (d):

Here, F22 is a focal length of the lens L22, and F23 is a focal length of the lens L23.

Conditional Expression (d) is a condition for defining a ratio of the focal length of the negative lens L22 to the focal length of the positive lens L23 in the second lens group GR2, that is, a power (refractive power) ratio. Since the resin material is used in each of the negative lens L22 and the positive lens L23, for example, when there is a change in environmental temperature, it is conceivable that the refractive index of the resin material may change or the lens shape may change by expansion or contraction. Conditional Expression (d) is a condition for constraining the change in the optical performance caused by the environmental fluctuation. When the result is greater than the upper limit of Conditional Expression (d), the power of the negative lens L22 is relatively large. Hence, the negative lens L22 has a great effect on the change in the optical performance caused by the environmental fluctuation, and defocus is remarkably caused by the environmental fluctuation, or an amount of focus correction for the defocus increases, and thereby the size of the apparatus increases. When the result is less than the lower limit of Conditional Expression (d), the power of the positive lens L23 is relatively large. Hence, the positive lens L23 has a great effect on the change in the optical performance caused by the environmental fluctuation, and defocus is remarkably caused by the environmental fluctuation, or an amount of focus correction for the defocus increases, and thereby the size of the apparatus increases.

In addition, in the zoom lens according to an embodiment of the present disclosure, it is more preferable that the numerical range of Conditional Expression (d) be set as a range of the following Conditional Expression (d′).

−1.03<F22/F23<−0.87 Conditional Expression (d′):

Further, it is more preferable that the zoom lens according to the embodiment of the present disclosure satisfy the following Conditional Expression (e).

0.34<FW/F23<0.60 Conditional Expression (e):

Here, FW is a focal length of the entire zoom lens at the wide-angle end.

Conditional Expression (e) is a condition for defining a ratio of the focal length of the positive lens L23 in the second lens group GR2 to the focal length of the zoom lens at the wide-angle end, that is, a power ratio. This is a condition for appropriately setting the power of the positive lens L23 made of resin. When the result is greater than the upper limit of Conditional Expression (e), the power of the positive lens L23 excessively increases. Hence, particularly, the change in the refractive index of the resin material is caused at the time of environmental fluctuation such as the temperature change, the defocus is caused by the shape change, and the image is deteriorated by the deterioration in the various aberrations such as the comatic aberration and the image field curvature. When the result is less than the lower limit of Conditional Expression (e), the power of the positive lens L23 excessively decreases. Therefore, the power of the negative lens L21 is dominant in the power of the second lens group GR2. Thus, it is difficult to correct all the various aberrations such as the comatic aberration and the image field curvature, and the image deteriorates.

In addition, in the zoom lens according to an embodiment of the present disclosure, it is more preferable that the numerical range of Conditional Expression (e) be set as a range of the following Conditional Expression (e′).

0.37<FW/F23<0.57 Conditional Expression (e′):

Further, it is more preferable that the zoom lens according to the embodiment of the present disclosure satisfy the following Conditional Expression (f).

−0.88<FW/F2<−0.66 Conditional Expression (f):

Here, F2 is a focal length of the second lens group GR2.

Conditional Expression (f) is a condition for defining a ratio of the focal length of the second lens group GR2 to the focal length of the zoom lens at the wide-angle end, that is, a power ratio. This is a condition for appropriately setting the power of the second lens group GR2. When the result is greater than the upper limit of Conditional Expression (f), particularly the power of the negative meniscus lens L21 of the second lens group GR2 excessively decreases. Then, the amount of movement of the second lens group GR2, which is caused by the zooming at the time of power variation, increases. As a result, this causes an increase in the size of the apparatus and an increase in the front lens diameter of the zoom lens. When the result is less than the lower limit of Conditional Expression (f), particularly, the power of the negative meniscus lens L21 of the second lens group GR2 excessively increases. Thus, various aberrations such as the comatic aberration and the image field curvature deteriorate, and this causes image deterioration.

In addition, in the zoom lens according to an embodiment of the present disclosure, it is more preferable that the numerical range of Conditional Expression (f) be set as a range of the following Conditional Expression (f′).

−0.83<FW/F2<−0.71 Conditional Expression (f′):

Further, in the zoom lens according to the embodiment of the present disclosure, it is more preferable that at least one surface of the lens L22 be aspheric. Since the lens L22 employs the resin material, the refractive index thereof is mostly lower than that of the lens using the glass material. Hence, in order to obtain the power which is equal to the power of the lens using the glass material, the radius of curvature of each surface is set to be small. Hence, the various aberrations such as the comatic aberration and the image field curvature occurring on each surface increase, and this causes image deterioration. In order to suppress the image deterioration, at least one surface of the lens L22 is formed to be aspheric, and the aberrations are satisfactorily corrected.

Further, in the zoom lens according to the embodiment of the present disclosure, it is more preferable that at least one surface of the lens L23 be aspheric. Since the lens L23 employs the resin material, the refractive index thereof is mostly lower than that of the lens using the glass material. Hence, in order to obtain the power which is equal to the power of the lens using the glass material, the radius of curvature of each surface is set to be small. Hence, the various aberrations such as the comatic aberration and the image field curvature occurring on each surface increase, and this causes image deterioration. In order to suppress the image deterioration, at least one surface of the lens L23 is formed to be aspheric, and the aberrations are satisfactorily corrected.

Further, in the zoom lens according to the embodiment of the present disclosure, it is more preferable that the first lens group GR1 include a cemented lens formed of a negative meniscus lens L11 convex toward the object side and a positive meniscus lens L12 convex toward the object side, and satisfy the following Conditional Expressions (g), (h), and (i).

2.5<D12/D11<3.1 Conditional Expression (g):

1.72<Nd12<1.82 Conditional Expression (h)

0.41<(D11+D12)/FW<0.51 Conditional Expression (i):

Here, D11 is an on-axis center thickness of the lens L11, D12 is an on-axis center thickness of the lens L12, and Nd12 is a d-line refractive index of the lens L12.

Conditional Expression (g) is a condition for defining a ratio of the center thickness of the positive meniscus lens L12 to the center thickness of the negative meniscus lens L11 of the first lens group GR1. This is a condition for appropriately setting the center thickness of the lens L12, which is dominant in the center thickness of the first lens group GR1, as a ratio in a case where the lens L11 is set as a reference. The power of the negative lens L21 is dominant in the power of the second lens group GR2. However, when the power excessively increases, various aberrations deteriorate. Hence, it is necessary to suppress the aberrations in appropriate ranges. Accordingly, by forming the positive lens L12 of the first lens group GR1 in a meniscus shape, the power is prevented from becoming excessively large. Here, by decreasing the center thickness of the lens L12 having a meniscus shape, the power is reduced and the thickness of the lens is reduced as much as possible. This configuration has an object to reduce the weight of the first lens group GR1. When the result is greater than the upper limit of Conditional Expression (g), the center thickness of the lens L12 excessively increases, and the weight of the first lens group GR1 increases. When the result is less than the lower limit of Conditional Expression (g), the center thickness of the lens L12 excessively decreases. Hence, it is difficult to secure the edge thickness, and there is a problem in the formability. Further, a sufficient power for the lens L12 is not secured, and particularly, it is difficult to correct the chromatic aberration on the telephoto side.

Conditional Expression (h) is a condition for defining a d-line refractive index of the lens L12 of the first lens group GR1. Since the lens L12 has a meniscus shape, it is necessary to secure a power of the lens L12 by increasing the refractive index of the material as much as possible. Meanwhile, when the refractive index as a characteristic of a material increases, the Abbe number decreases, and this has an effect on particularly the chromatic aberration correction on the telephoto side. When the result is greater than the upper limit of Conditional Expression (h), the Abbe number of the applied material excessively decreases, and thus it is difficult to correct particularly the chromatic aberration on the telephoto side. When the result is less than the lower limit of Conditional Expression (h), the radius of curvature of each surface of the lens L12 decreases. Then, particularly the various aberrations on the telephoto side deteriorate, or the center thickness of the lens L12 increases. As a result, this leads to an increase in the weight.

Conditional Expression (i) is a condition for defining a ratio of the center thickness of the first lens group GR1 to the focal length of the zoom lens at the wide-angle end. This is a condition for appropriately setting the center thickness of the first lens group GR1, and is also a condition for appropriately setting the relationship with the power of the second lens group GR2. When the result is greater than the upper limit of Conditional Expression (i), the center thickness of the first lens group GR1 excessively increases, and thus the weight of the first lens group GR1 increases. When the result is less than the lower limit of Conditional Expression (i), the center thickness of the first lens group GR1 excessively decreases, and particularly the power of the lens L12 decreases. Thus, it is difficult to correct the various aberrations at the telephoto end, and this leads to image deterioration.

In addition, in the zoom lens according to an embodiment of the present disclosure, it is more preferable that the numerical ranges of Conditional Expressions (g), (h), and (i) be set as ranges of the following Conditional Expressions (g′), (h′), and (i′).

2.68<D12/D11<2.98 Conditional Expression (g′):

1.74<Nd12<1.80 Conditional Expression (h′):

0.43<(D11+D12)/FW<0.49 Conditional Expression (i′):

The imaging apparatus according to the embodiment of the present disclosure has the above-mentioned zoom lens, and has high imaging performance. In addition, the apparatus has a wide angle of view and a small size even in the photography state and the collapsed state, and exhibits high performance in the zoom ratio which is equal to or greater than 6 times and equal to or less than 15 times. Further, it is possible to realize an imaging apparatus with a low weight and with good portability and operability.

In addition, in the zoom lens according to the embodiment of the present disclosure, one lens group or a part of one lens group of the lens groups from the first lens group GR1 to the fourth lens group GR4 is moved (shifted) in a direction substantially perpendicular to the optical axis, whereby it is possible to shift an image. As described above, by moving the lens group or a part thereof in the direction substantially perpendicular to the optical axis, it is possible to interlock a detection system which detects image blur, a driving system which shifts the lens groups, and a control system which applies an amount of shift to the driving system on the basis of the output of the detection system. Thereby, the zoom lens can be made to also function as a vibration-proof optical system. In particular, the zoom lens according to the embodiment of the present disclosure shifts an image with small aberration fluctuation by shifting the entire third lens group GR3 in the direction substantially perpendicular to the optical axis.

Hereinafter, a mode for carrying out the present technology (hereinafter referred to as an embodiment) will be described. The description thereof will be given in order of the following items:

1. First Embodiment (Numerical Value Example 1);

2. Second Embodiment (Numerical Value Example 2);

3. Third Embodiment (Numerical Value Example 3); and

4. Application Example (Imaging Apparatus).

It should be noted that the reference signs and the like shown in the following tables and description are defined as follows. That is, “si” indicates the surface number which represents the i-th surface counted from the object side. “ri” indicates the radius of curvature of the i-th surface counted from the object side. “di” indicates the on-axis surface spacing between the i-th surface and the i+1-th surface counted from the object side. “ni” indicates the refractive index of a raw material or a glass material, of which the object side is the i-th surface, at the d-line (a wavelength of 587.6 nm). “νi” indicates the Abbe number of the raw material or the glass material, of which the object side is the i-th surface, at the d-line. In addition, in terms of the radius of curvature, “∞” indicates that the surface is flat. Further, “ASP” attached to the surface number indicates that the surface is formed to be aspheric. Furthermore, “f” indicates the focal length. “Fno” indicates the F number. “ω” indicates the half angle of view.

Further, in zoom lenses used in the embodiments, some lens surfaces are formed to be aspheric as described above. Assuming that the distance (sag amount) from the vertex of the lens surface in the optical axis direction is “x”, the height thereof in the direction perpendicular to the optical axis is “y”, the paraxial curvature at the lens vertex is “c”, and conic constant is “κ”, the following expression can be established.

x=y²c²/(1+(1−(1+κ)y²c²)^{1/2})+A4y⁴+A6y⁶+A8y⁸+A10y¹⁰

In addition, A4, A6, A8, and A10 are 4th-order, 6th-order, 8th-order, and 10th-order aspheric coefficients.

### 1. First Embodiment

### Lens Configuration

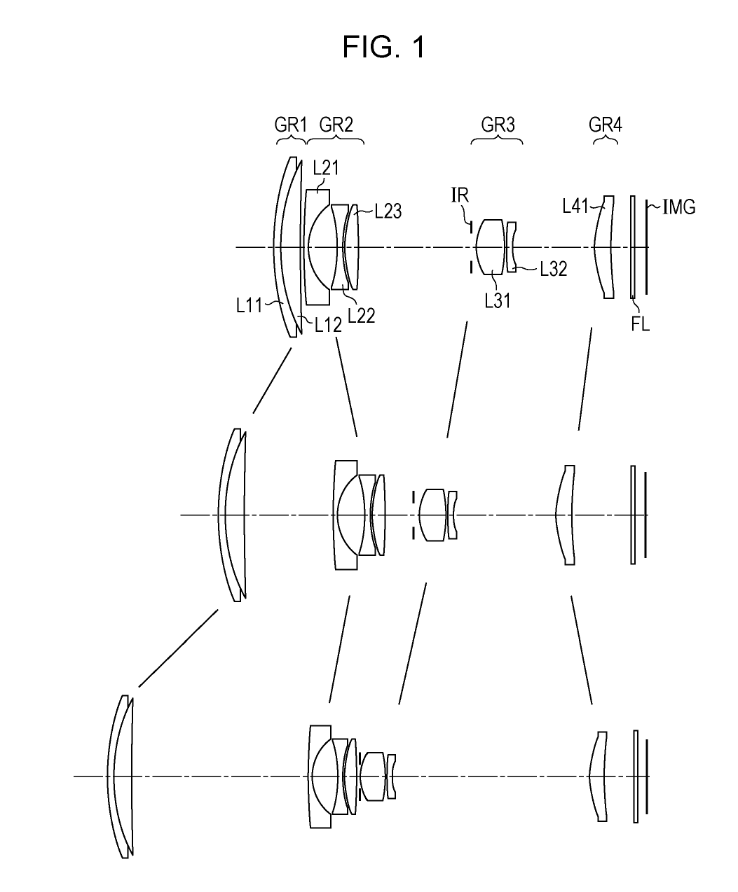

FIG. 1 is a diagram illustrating a lens configuration of the zoom lens according to a first embodiment of the present technology. The zoom lens according to the first embodiment includes, in order from the object side, a first lens group GR1 having a positive refractive power, a second lens group GR2 having a negative refractive power, a third lens group GR3 having a positive refractive power, and a fourth lens group GR4 having a positive refractive power.

The first lens group GR1 includes, in order from the object side, a cemented lens formed of the negative meniscus lens L11 convex toward the object side and the positive meniscus lens L12 convex toward the object side.

The second lens group GR2 includes, in order from the object side, a negative meniscus lens L21 which is concave toward the image plane side, a negative lens L22 which is concave toward both sides and is made of resin and of which both surfaces are aspheric, and a positive lens L23 which is convex toward both sides and is made of resin and of which both surfaces are aspheric.

The third lens group GR3 includes, in order from the object side, a positive lens L31, which is convex toward both sides and of which both surfaces are aspheric, and a negative meniscus lens L32 which is concave toward the image plane side and of which both surfaces are aspheric.

The fourth lens group GR4 includes a single positive lens L41 of which both surfaces are aspheric and which is made of resin.

A diaphragm IR is disposed on the object side of the third lens group GR3. A filter FL is disposed between the fourth lens group GR4 and the image plane IMG. Specification of Zoom Lens

Table 1 shows the lens data of Numerical Example 1 of the zoom lens, to which specific numerical values are applied, according to the first embodiment.

TABLE 1

| si | | ri | di | ni | νi |
|---|---|---|---|---|---|
| 1 | | 22.452 | 0.63 | 1.9460 | 18.0 |
| 2 | | 17.265 | 1.70 | 1.7725 | 49.6 |
| 3 | | 125.163 | (VARIABLE) | | |
| 4 | | 62.777 | 0.40 | 1.7725 | 49.6 |
| 5 | | 4.667 | 2.50 | | |
| 6 | ASP | −26.124 | 0.50 | 1.5311 | 55.9 |
| 7 | ASP | 7.075 | 0.10 | | |
| 8 | ASP | 8.013 | 1.30 | 1.6355 | 23.9 |
| 9 | ASP | −67.129 | (VARIABLE) | | |
| 10 | (DIAPHRAGM) | ∞ | 0.00 | | |
| 11 | ASP | 4.238 | 2.50 | 1.6188 | 63.9 |
| 12 | ASP | −9.475 | 0.12 | | |
| 13 | ASP | 13.228 | 0.54 | 1.8212 | 24.1 |
| 14 | ASP | 4.369 | (VARIABLE) | | |
| 15 | ASP | 8.130 | 1.42 | 1.5311 | 55.9 |
| 16 | ASP | 15.240 | (VARIABLE) | | |
| 17 | | ∞ | 0.30 | 1.5168 | 64.2 |
| 18 | | ∞ | 1.00 | | |

In the zoom lens according to the first embodiment, the following surfaces are formed to be aspheric: both surfaces (the sixth surface and the seventh surface) of the negative lens L22 of the second zoom lens group GR2; both surfaces (the eighth surface and the ninth surface) of the positive lens L23 of the second zoom lens group GR2; both surfaces (the eleventh surface and the twelfth surface) of the positive lens L31 of the third zoom lens group GR3; both surfaces (the thirteenth surface and the fourteenth surface) of the negative lens L32; and both surfaces (the fifteenth surface and the sixteenth surface) of the positive lens L41 of the fourth zoom lens group GR4. Table 2 shows the conic constants K and the 4th-order, 6th-order, 8th-order, and 10th-order aspheric coefficients A4, A6, A8, and A10 of the surfaces. In Table 2 and the following tables showing the aspheric surface coefficients, the reference sign “E-i” represents an exponential expression having a base of 10, that is, “10⁻ⁱ”. For example, “0.12345E-05” represents “0.12345×10⁻⁵”.

TABLE 2

| si | κ | A4 | A6 | A8 | A10 |
|---|---|---|---|---|---|
| 6 | 0 | −2.3285E−03 | 6.2903E−05 | 0 | 0 |
| 7 | 0 | −4.7140E−03 | 2.6629E−04 | −5.4217E−06 | 0 |
| 8 | 0 | −2.4427E−03 | 1.9925E−04 | −3.8063E−06 | 0 |
| 9 | 0 | −8.7903E−04 | 5.7446E−05 | 0 | 0 |
| 11 | 0 | −5.4522E−04 | −3.7615E−05 | −2.5769E−07 | −8.7125E−07 |
| 12 | 0 | 5.5760E−03 | −7.0000E−04 | 6.4363E−06 | 0 |
| 13 | 0 | −4.7372E−04 | 8.3750E−04 | −2.5180E−04 | 1.4077E−05 |
| 14 | 0 | −2.7546E−03 | 1.6423E−03 | −2.5299E−04 | 1.1166E−05 |
| 15 | 0 | −1.0269E−03 | 4.1235E−05 | −1.5684E−06 | −3.7250E−08 |
| 16 | 0 | −1.2425E−03 | 6.0000E−05 | −2.9911E−06 | 0 |

Table 3 shows the focal lengths f, the F numbers Fno, and the half angles of view ω in the wide-angle end state, the middle focal length state, and the telephoto end state in Numerical Example 1.

TABLE 3

| | | MIDDLE | |
|---|---|---|---|
| | WIDE-ANGLE | FOCAL | TELEPHOTO |
| | END | LENGTH | END |
| f | 4.96 | 13.51 | 35.96 |
| Fno | 3.4 | 4.8 | 6.7 |
| ω | 40.2 | 16.3 | 6.1 |

In the zoom lens according to the first embodiment, during the power variation between the wide-angle end state and the telephoto end state, the following spacings change: a surface spacing d3 between the first zoom lens group GR1 and the second zoom lens group GR2; a surface spacing d9 between the second zoom lens group GR2 and the third zoom lens group GR3; a surface spacing d14 between the third zoom lens group GR3 and the fourth zoom lens group GR4; and a surface spacing d16 between the fourth zoom lens group GR4 and the filter FL. Table 4 shows the variable spacings of the surface spacings in the wide-angle end state, the middle focal length state, and the telephoto end state in this case.

TABLE 4

| | | MIDDLE | |
|---|---|---|---|
| | WIDE-ANGLE | FOCAL | TELEPHOTO |
| | END | LENGTH | END |
| TOTAL LENS LENGTH | 32.9 | 39.2 | 52.8 |
| d3 | 0.350 | 8.203 | 17.276 |
| d9 | 10.421 | 3.064 | 0.250 |
| d14 | 7.278 | 9.496 | 19.267 |
| d16 | 1.812 | 5.448 | 2.996 |

### Aberration of Zoom Lens

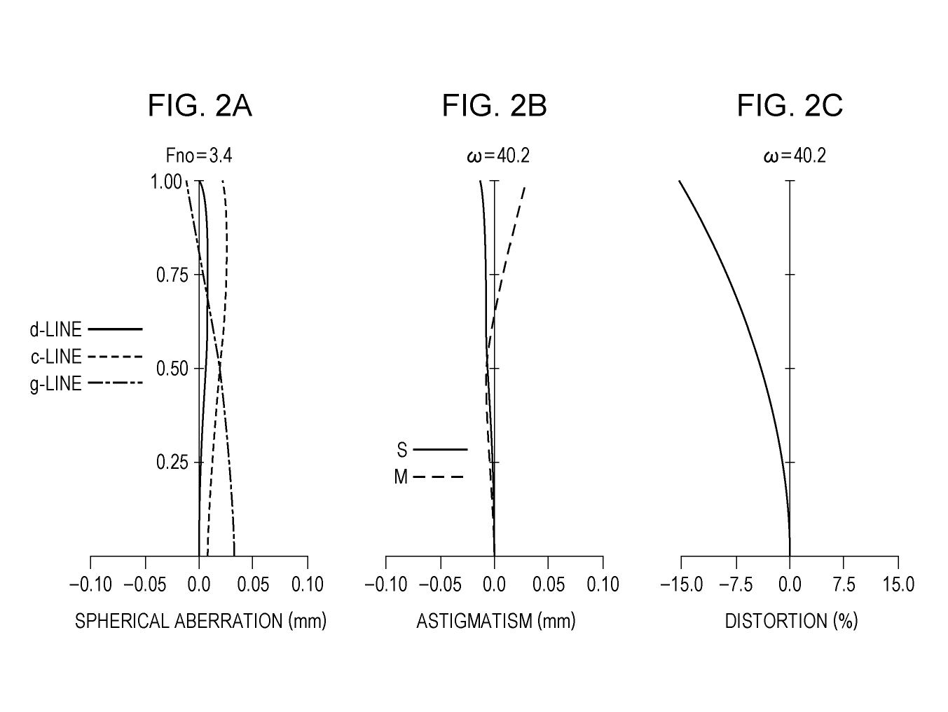

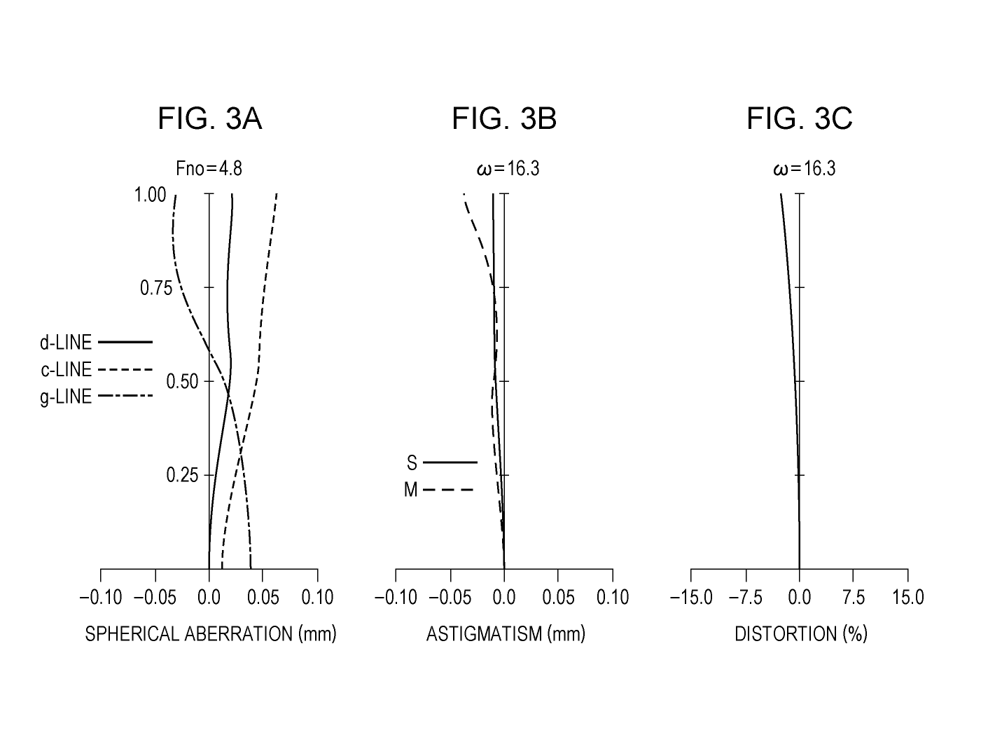

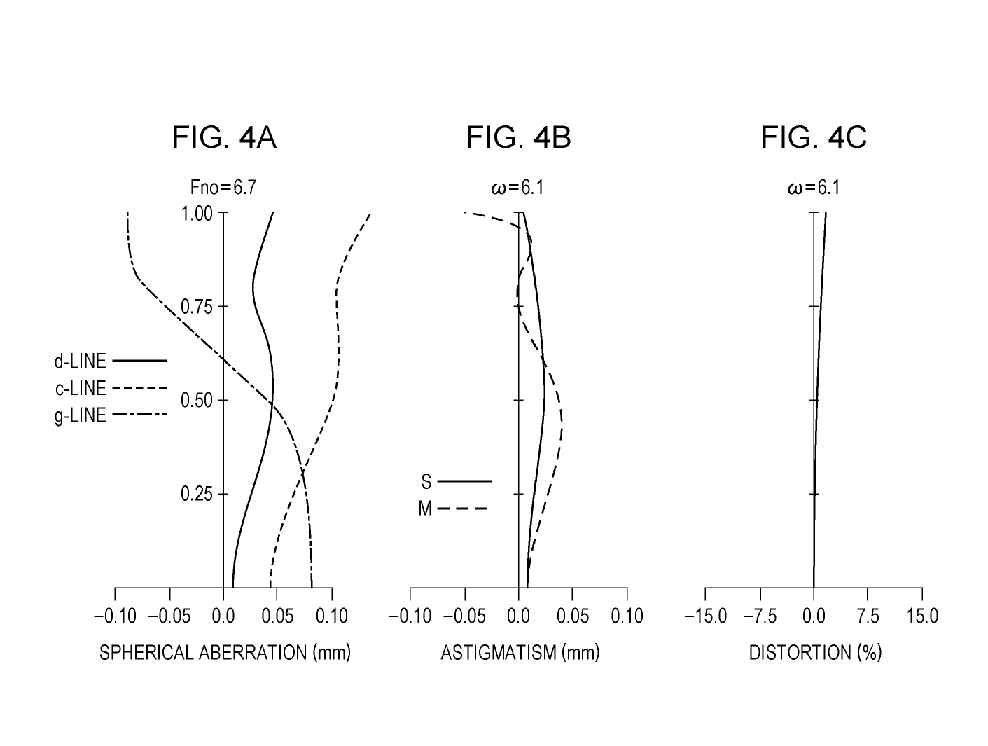

FIGS. 2A to 4C are diagrams of various aberrations of the zoom lens according to the first embodiment of the present technology. FIGS. 2A to 2C show diagrams of various aberrations in the wide-angle end state. FIGS. 3A to 3C show various aberrations diagrams in the middle focal length state. FIGS. 4A to 4C show diagrams of various aberrations in the telephoto end state. In the diagrams, FIGS. 2A, 3A, and 4A show spherical aberration diagrams, FIGS. 2B, 3B, and 4B show astigmatism diagrams (image field curvature diagrams), and FIGS. 2C, 3C, and 4C show distortion diagrams.

In addition, in each of the spherical aberration diagrams and spherical aberration diagrams to be described later, the solid line represents a value at the d-line (the wavelength of 587.6 nm), the dashed line represents a value at the c-line (the wavelength of 656.3 nm), and the dot-dashed line represents a value at the g-line (the wavelength of 435.8 nm). Further, in each of the astigmatism diagrams and astigmatism diagrams to be described later, the solid line represents a value on the sagittal image plane, and the dashed line shows a value on the meridional image plane.

As can be clearly seen from the aberration diagrams, in Numerical Example 1, it is possible to obtain an excellent imaging performance by satisfactorily correcting various aberrations.

### 2. Second Embodiment

### Lens Configuration

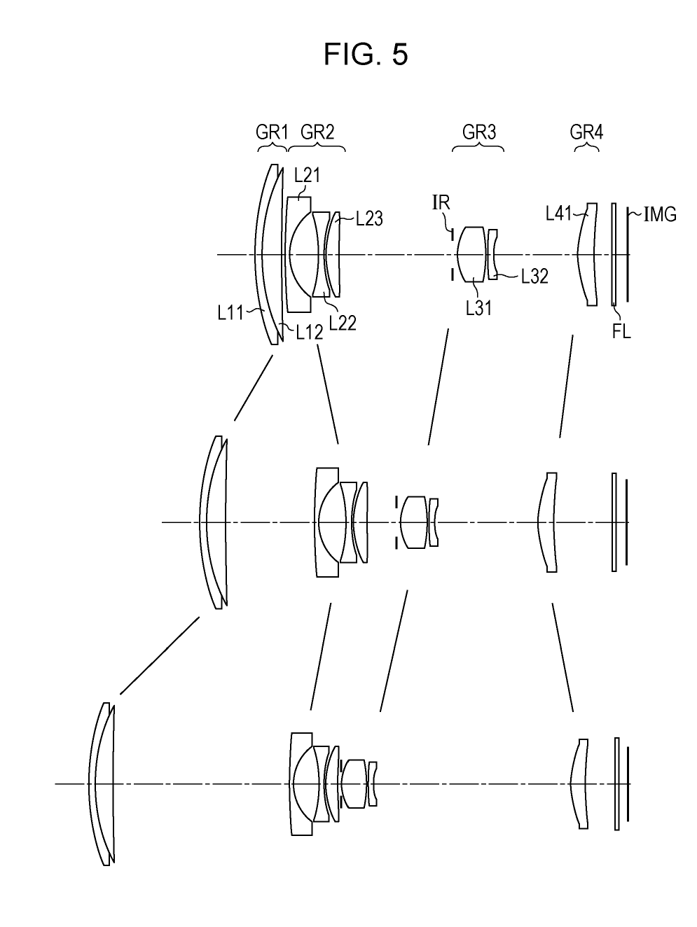

FIG. 5 is a diagram illustrating a lens configuration of the zoom lens according to a second embodiment of the present technology. The zoom lens according to the second embodiment includes, in order from the object side, a first lens group GR1 having a positive refractive power, a second lens group GR2 having a negative refractive power, a third lens group GR3 having a positive refractive power, and a fourth lens group GR4 having a positive refractive power.

The first lens group GR1 includes, in order from the object side, a cemented lens formed of the negative meniscus lens L11 convex toward the object side and the positive meniscus lens L12 convex toward the object side.

The second lens group GR2 includes, in order from the object side, a negative meniscus lens L21 which is concave toward the image plane side, a negative lens L22 which is concave toward both sides and is made of resin and of which both surfaces are aspheric, and a positive lens L23 which is convex toward both sides and is made of resin and of which both surfaces are aspheric.

The third lens group GR3 includes, in order from the object side, a positive lens L31, which is convex toward both sides and of which both surfaces are aspheric, and a negative meniscus lens L32 which is concave toward the image plane side and of which both surfaces are aspheric.

The fourth lens group GR4 includes a single positive lens L41 of which both surfaces are aspheric and which is made of resin.

A diaphragm IR is disposed on the object side of the third lens group GR3. A filter FL is disposed between the fourth lens group GR4 and the image plane.

In the second embodiment, compared with the first embodiment, the positive lens L23 of the second lens group GR2 is made of a different resin material.

### Specification of Zoom Lens

Table 5 shows the lens data of Numerical Example 2 of the zoom lens, to which specific numerical values are applied, according to the second embodiment.

TABLE 5

| si | | ri | di | ni | νi |
|---|---|---|---|---|---|
| 1 | | 23.213 | 0.60 | 1.9460 | 18.0 |
| 2 | | 17.732 | 1.68 | 1.7725 | 49.6 |
| 3 | | 151.945 | (VARIABLE) | | |
| 4 | | 63.080 | 0.40 | 1.7725 | 49.6 |
| 5 | | 4.709 | 2.40 | | |
| 6 | ASP | −23.201 | 0.50 | 1.5311 | 55.9 |
| 7 | ASP | 5.677 | 0.10 | | |
| 8 | ASP | 6.224 | 1.38 | 1.6074 | 27.0 |
| 9 | ASP | −59.362 | (VARIABLE) | | |
| 10 | (DIAPHRAGM) | ∞ | 0.00 | | |
| 11 | ASP | 4.406 | 2.50 | 1.6188 | 63.9 |
| 12 | ASP | −9.214 | 0.19 | | |
| 13 | ASP | 13.436 | 0.54 | 1.8212 | 24.1 |
| 14 | ASP | 4.521 | (VARIABLE) | | |
| 15 | ASP | 8.351 | 1.42 | 1.5311 | 55.9 |
| 16 | ASP | 15.313 | (VARIABLE) | | |
| 17 | | ∞ | 0.30 | 1.5168 | 64.2 |
| 18 | | ∞ | 1.00 | | |

In the zoom lens according to the second embodiment, the following surfaces are formed to be aspheric: both surfaces (the sixth surface and the seventh surface) of the negative lens L22 of the second zoom lens group GR2; both surfaces (the eighth surface and the ninth surface) of the positive lens L23 of the second zoom lens group GR2; both surfaces (the eleventh surface and the twelfth surface) of the positive lens L31 of the third zoom lens group GR3; both surfaces (the thirteenth surface and the fourteenth surface) of the negative lens L32; and both surfaces (the fifteenth surface and the sixteenth surface) of the positive lens L41 of the fourth zoom lens group GR4. Table 6 shows the conic constants κ and the 4th-order, 6th-order, 8th-order, and 10th-order aspheric coefficients A4, A6, A8, and A10 of the surfaces.

TABLE 6

| si | κ | A4 | A6 | A8 | A10 |
|---|---|---|---|---|---|
| 6 | 0 | −3.0037E−03 | 9.0777E−05 | 0 | 0 |
| 7 | 0 | −5.2385E−03 | 1.3332E−04 | −2.2829E−06 | 0 |
| 8 | 0 | −2.1751E−03 | 1.1276E−04 | −7.5654E−08 | 0 |
| 9 | 0 | −6.9145E−04 | 1.2866E−04 | 0 | 0 |
| 11 | 0 | −7.3449E−04 | −5.4594E−05 | −2.4967E−06 | −1.3111E−06 |
| 12 | 0 | 4.1909E−03 | −6.0831E−04 | 2.0573E−06 | 0 |
| 13 | 0 | −6.6479E−05 | 5.4680E−04 | −1.8667E−04 | 9.9177E−05 |
| 14 | 0 | −1.3946E−03 | 1.1420E−03 | −1.5502E−04 | 2.6460E−05 |
| 15 | 0 | −1.0904E−03 | 3.4834E−05 | −1.3573E−06 | −5.2332E−08 |
| 16 | 0 | −1.2959E−03 | 5.2380E−05 | −3.0000E−06 | 0 |

Table 7 shows the focal lengths f, the F numbers Fno, and the half angles of view ω in the wide-angle end state, the middle focal length state, and the telephoto end state in Numerical Example 2.

TABLE 7

| | | MIDDLE | |
|---|---|---|---|
| | WIDE-ANGLE | FOCAL | TELEPHOTO |
| | END | LENGTH | END |
| f | 4.96 | 13.51 | 35.87 |
| Fno | 3.5 | 4.8 | 6.7 |
| ω | 40.3 | 16.3 | 6.1 |

In the zoom lens according to the second embodiment, during the power variation between the wide-angle end state and the telephoto end state, the following spacings change: a surface spacing d3 between the first zoom lens group GR1 and the second zoom lens group GR2; a surface spacing d9 between the second zoom lens group GR2 and the third zoom lens group GR3; a surface spacing d14 between the third zoom lens group GR3 and the fourth zoom lens group GR4; and a surface spacing d16 between the fourth zoom lens group GR4 and the filter FL. Table 8 shows the variable spacings of the surface spacings in the wide-angle end state, the middle focal length state, and the telephoto end state in this case.

TABLE 8

| | | MIDDLE | |
|---|---|---|---|
| | WIDE-ANGLE | FOCAL | TELEPHOTO |
| | END | LENGTH | END |
| TOTAL LENS LENGTH | 32.9 | 39.2 | 52.8 |
| d3 | 0.350 | 8.223 | 17.320 |
| d9 | 10.458 | 3.079 | 0.250 |
| d14 | 7.436 | 9.502 | 19.264 |
| d16 | 1.644 | 5.413 | 2.955 |

### Aberration of Zoom Lens

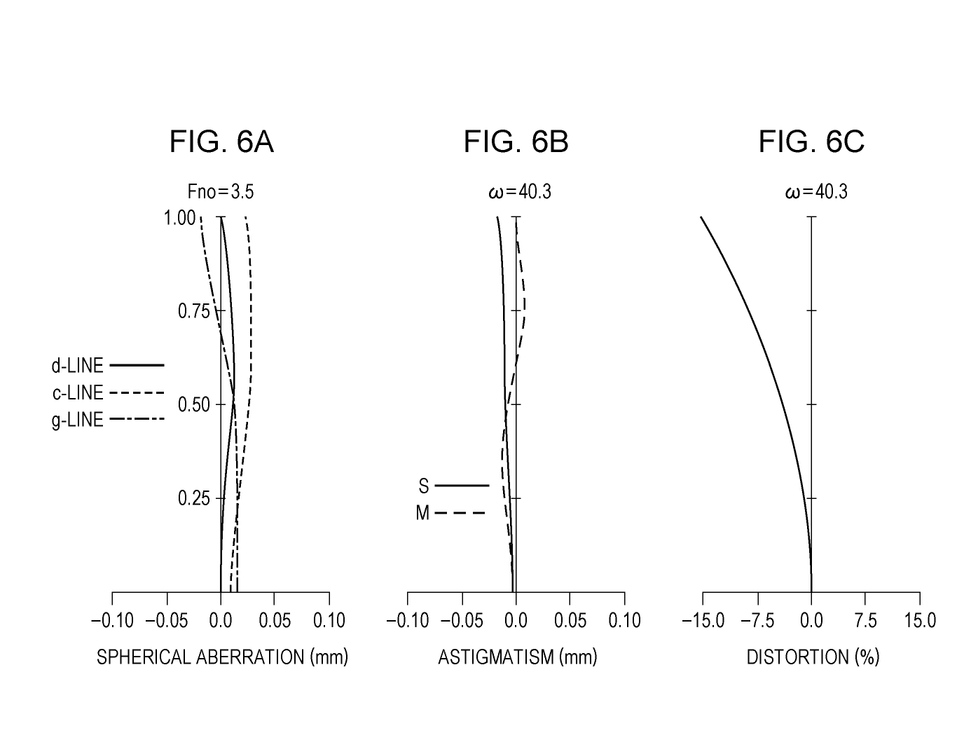

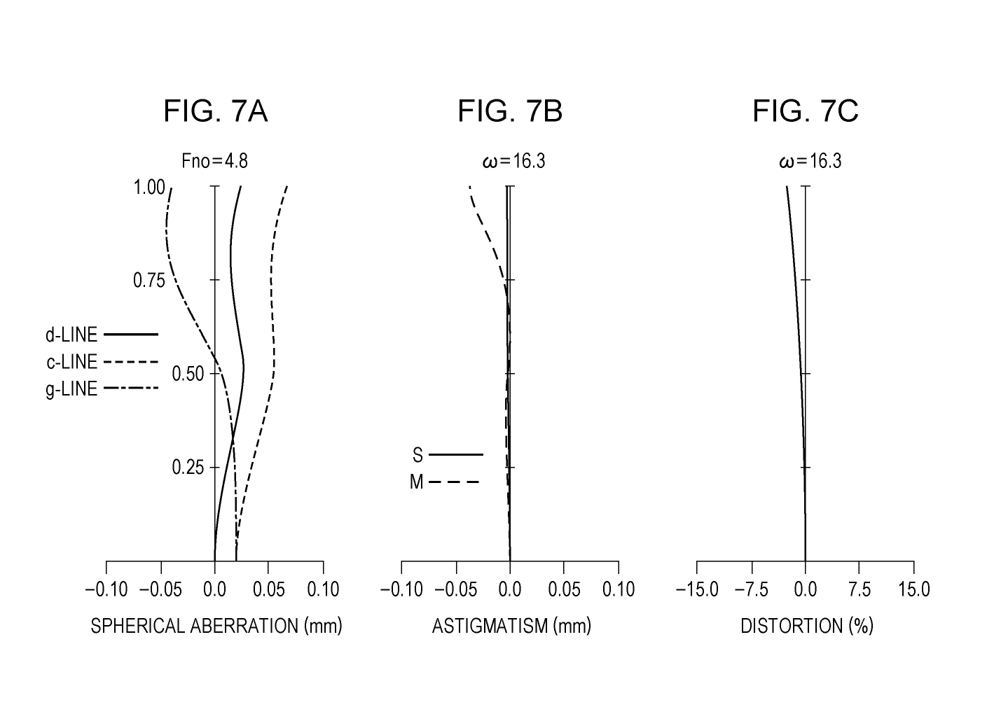

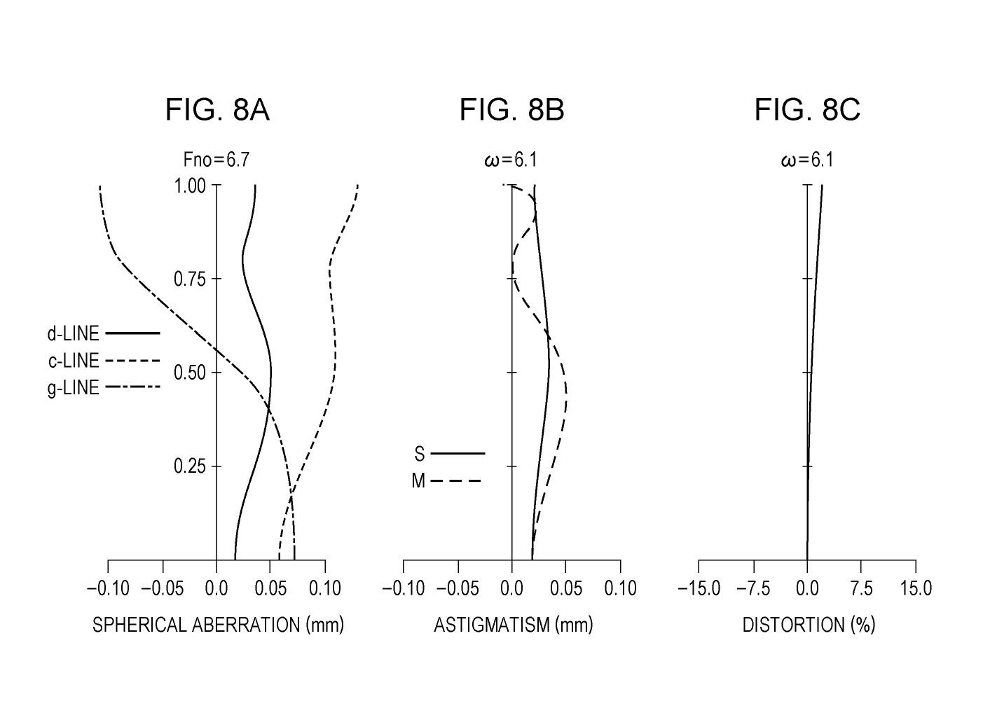

FIGS. 6A to 8C are diagrams of various aberrations of the zoom lens according to the second embodiment of the present technology. FIGS. 6A to 6C show diagrams of various aberrations in the wide-angle end state. FIGS. 7A to 7C show various aberrations diagrams in the middle focal length state. FIGS. 8A to 8C show diagrams of various aberrations in the telephoto end state. In the diagrams, FIGS. 6A, 7A, and 8A show spherical aberration diagrams, FIGS. 6B, 7B, and 8B show astigmatism diagrams (image field curvature diagrams), and FIGS. 6C, 7C, and 8C show distortion diagrams.

As can be clearly seen from the aberration diagrams, in Numerical Example 2, it is possible to obtain an excellent imaging performance by satisfactorily correcting various aberrations.

### 3. Third Embodiment

### Lens Configuration

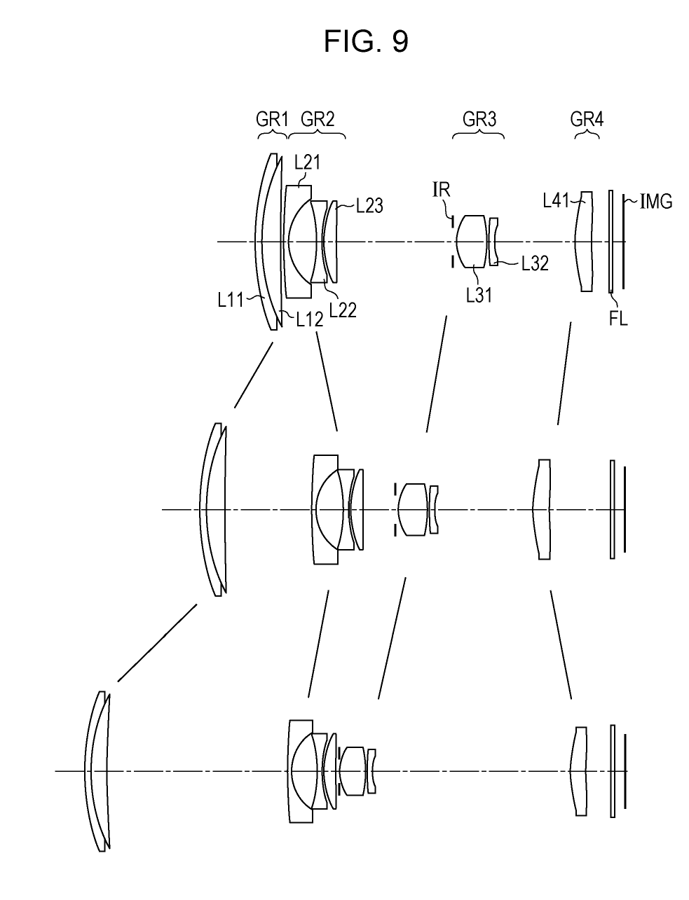

FIG. 9 is a diagram illustrating a lens configuration of the zoom lens according to a third embodiment of the present technology. The zoom lens according to the third embodiment includes, in order from the object side, a first lens group GR1 having a positive refractive power, a second lens group GR2 having a negative refractive power, a third lens group GR3 having a positive refractive power, and a fourth lens group GR4 having a positive refractive power.

The first lens group GR1 includes, in order from the object side, a cemented lens formed of the negative meniscus lens L11 convex toward the object side and the positive meniscus lens L12 convex toward the object side.

The second lens group GR2 includes, in order from the object side, a negative meniscus lens L21 which is concave toward the image plane side, a negative lens L22 which is concave toward both sides and is made of resin and of which both surfaces are aspheric, and a positive lens L23 which is convex toward both sides and is made of resin and of which both surfaces are aspheric.

The third lens group GR3 includes, in order from the object side, a positive lens L31, which is convex toward both sides and of which both surfaces are aspheric, and a negative meniscus lens L32 which is concave toward the image plane side and of which both surfaces are aspheric.

The fourth lens group GR4 includes a single positive lens L41 of which both surfaces are aspheric and which is made of resin.

A diaphragm IR is disposed on the object side of the third lens group GR3. A filter FL is disposed between the fourth lens group GR4 and the image plane.

In the third embodiment, compared with the first embodiment, the variable-power ratio is different.

### Specification of Zoom Lens

Table 9 shows the lens data of Numerical Example 3 of the zoom lens, to which specific numerical values are applied, according to the third embodiment.

TABLE 9

| si | | ri | di | ni | νi |
|---|---|---|---|---|---|
| 1 | | 23.367 | 0.60 | 1.9460 | 18.0 |
| 2 | | 17.933 | 1.64 | 1.7725 | 49.6 |
| 3 | | 138.287 | (VARIABLE) | | |
| 4 | | 63.002 | 0.40 | 1.7725 | 49.6 |
| 5 | | 4.763 | 2.60 | | |
| 6 | ASP | −25.286 | 0.50 | 1.5311 | 55.9 |
| 7 | ASP | 8.085 | 0.10 | | |
| 8 | ASP | 9.419 | 1.19 | 1.6355 | 23.9 |
| 9 | ASP | −50.001 | (VARIABLE) | | |
| 10 | (DIAPHRAGM) | ∞ | 0.00 | | |
| 11 | ASP | 4.281 | 2.80 | 1.6188 | 63.9 |
| 12 | ASP | −10.308 | 0.10 | | |
| 13 | ASP | 15.405 | 0.50 | 1.8212 | 24.1 |
| 14 | ASP | 4.851 | (VARIABLE) | | |
| 15 | ASP | 9.967 | 1.50 | 1.5311 | 55.9 |
| 16 | ASP | 18.802 | (VARIABLE) | | |
| 17 | | ∞ | 0.30 | 1.5168 | 64.2 |
| 18 | | ∞ | 1.00 | | |

In the zoom lens according to the third embodiment, the following surfaces are formed to be aspheric: both surfaces (the sixth surface and the seventh surface) of the negative lens L22 of the second zoom lens group GR2; both surfaces (the eighth surface and the ninth surface) of the positive lens L23 of the second zoom lens group GR2; both surfaces (the eleventh surface and the twelfth surface) of the positive lens L31 of the third zoom lens group GR3; both surfaces (the thirteenth surface and the fourteenth surface) of the negative lens L32; and both surfaces (the fifteenth surface and the sixteenth surface) of the positive lens L41 of the fourth zoom lens group GR4. Table 10 shows the conic constants κ and the 4th-order, 6th-order, 8th-order, and 10th-order aspheric coefficients A4, A6, A8, and A10 of the surfaces.

TABLE 10

| si | κ | A4 | A6 | A8 | A10 |
|---|---|---|---|---|---|
| 6 | 0 | −3.0256E−03 | 8.3766E−05 | 0 | 0 |
| 7 | 0 | −4.4547E−03 | 1.8994E−04 | −2.9129E−06 | 0 |
| 8 | 0 | −1.5831E−03 | 1.3872E−04 | −1.5349E−08 | 0 |
| 9 | 0 | −7.5078E−04 | 8.3090E−05 | 0 | 0 |
| 11 | 0 | −3.8585E−04 | −2.7594E−05 | 1.5526E−06 | −5.1352E−07 |
| 12 | 0 | 5.3747E−03 | −7.0000E−04 | 1.6293E−05 | 0 |
| 13 | 0 | −4.0003E−04 | 7.7025E−04 | −2.5310E−04 | 1.6618E−05 |
| 14 | 0 | −2.1747E−03 | 1.5481E−03 | −2.6526E−04 | 1.6744E−05 |
| 15 | 0 | −1.2672E−03 | 4.9526E−05 | −2.3491E−06 | −2.1117−08 |
| 16 | 0 | −1.5313E−03 | 5.9798E−05 | −3.0000E−06 | 0 |

Table 11 shows the focal lengths f, the F numbers Fno, and the half angles of view ω in the wide-angle end state, the middle focal length state, and the telephoto end state in Numerical Example 3.

TABLE 11

| | | MIDDLE | |
|---|---|---|---|
| | WIDE-ANGLE | FOCAL | TELEPHOTO |
| | END | LENGTH | END |
| f | 4.97 | 13.51 | 36.54 |
| Fno | 3.5 | 4.8 | 6.9 |
| ω | 40.2 | 16.3 | 6.0 |

In the zoom lens according to the third embodiment, during the power variation between the wide-angle end state and the telephoto end state, the following spacings change: a surface spacing d3 between the first zoom lens group GR1 and the second zoom lens group GR2; a surface spacing d9 between the second zoom lens group GR2 and the third zoom lens group GR3; a surface spacing d14 between the third zoom lens group GR3 and the fourth zoom lens group GR4; and a surface spacing d16 between the fourth zoom lens group GR4 and the filter FL. Table 12 shows the variable spacings of the surface spacings in the wide-angle end state, the middle focal length state, and the telephoto end state in this case.

TABLE 12

| | | MIDDLE | |
|---|---|---|---|
| | WIDE-ANGLE | FOCAL | TELEPHOTO |
| | END | LENGTH | END |
| TOTAL LENS LENGTH | 33.3 | 39.1 | 53.0 |
| d3 | 0.350 | 8.000 | 17.662 |
| d9 | 10.837 | 3.156 | 0.200 |
| d14 | 7.260 | 9.134 | 19.372 |
| d16 | 1.613 | 5.567 | 2.528 |

### Aberration of Zoom Lens

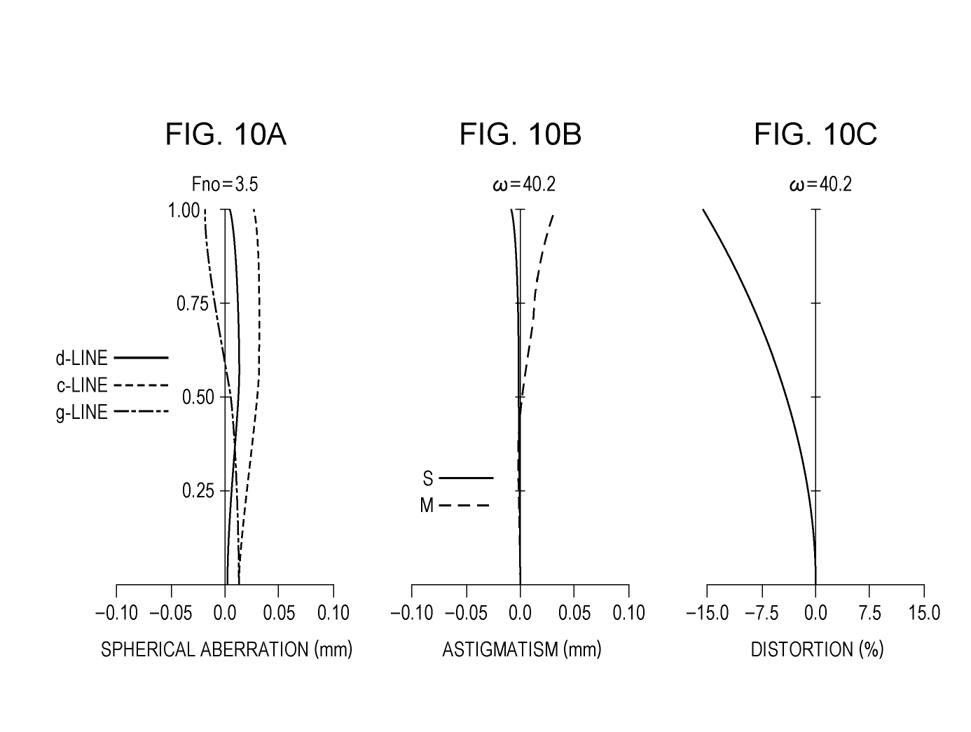

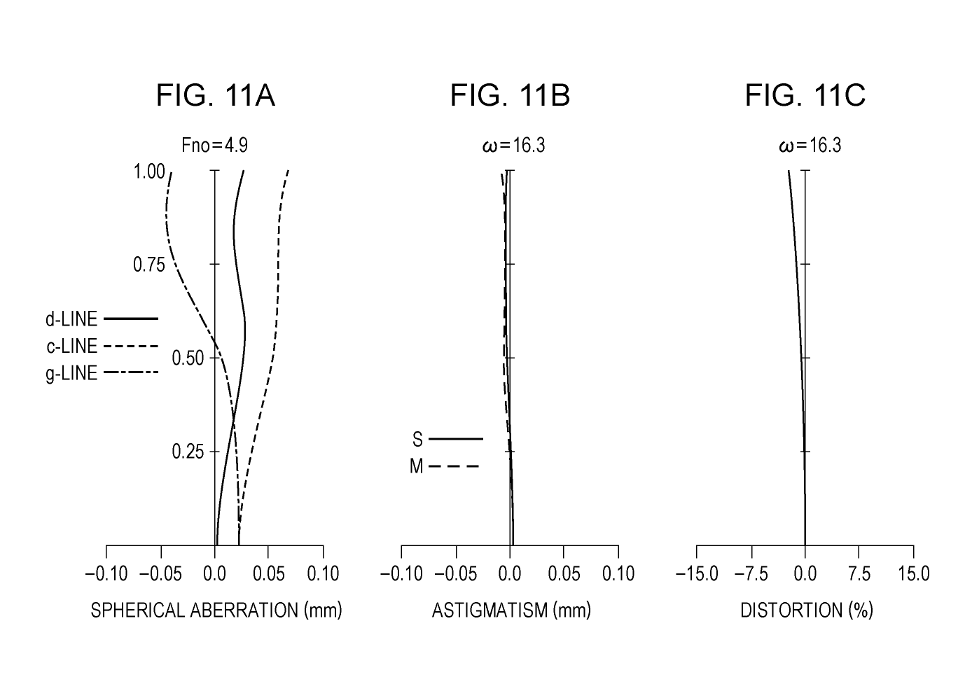

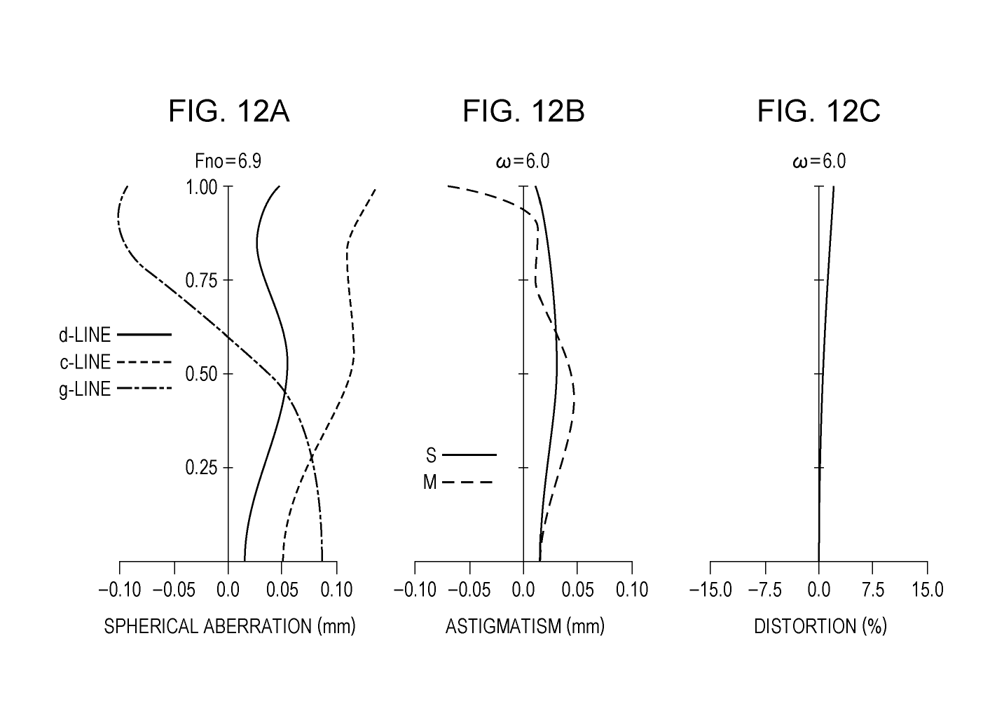

FIGS. 10A to 12C are diagrams of various aberrations of the zoom lens according to the third embodiment of the present technology. FIGS. 10A to 10C show diagrams of various aberrations in the wide-angle end state. FIGS. 11A to 11C show various aberrations diagrams in the middle focal length state. FIGS. 12A to 12C show diagrams of various aberrations in the telephoto end state. In the diagrams, FIGS. 10A, 11A, and 12A show spherical aberration diagrams, FIGS. 10A, 11A, and 12A show astigmatism diagrams (image field curvature diagrams), and FIGS. 10C, 11C, and 12C show distortion diagrams.

As can be clearly seen from the aberration diagrams, in Numerical Example 3, it is possible to obtain an excellent imaging performance by satisfactorily correcting various aberrations.

### Summary of Conditional Expressions

Table 13 shows values of Numerical Examples 1 to 3 of the first to third embodiments. As can be clearly seen from the values, Conditional Expressions (a) to (i) are satisfied. Further, as can be seen from each aberration diagram, at the wide-angle end and the telephoto end, various aberrations are corrected with balance.

TABLE 13

| | | NUMER- | NUMER- | NUMER- |
|---|---|---|---|---|
| | | ICAL | ICAL | ICAL |
| | | EXAM- | EXAM- | EXAM- |
| | | PLE 1 | PLE 2 | PLE 3 |
| | Nd22 | 1.5311 | 1.5311 | 1.5311 |
| | Nd23 | 1.6355 | 1.6074 | 1.6355 |
| | νd22 | 55.9 | 55.9 | 55.9 |
| | νd23 | 23.9 | 27.0 | 23.9 |
| | F22 | −10.38 | −8.50 | −11.43 |
| | F23 | 11.23 | 9.27 | 12.45 |
| | FW | 4.96 | 4.96 | 4.97 |
| | F2 | −6.36 | −6.35 | −6.50 |
| | D11 | 0.63 | 0.6 | 0.6 |
| | D12 | 1.6982 | 1.6781 | 1.6424 |
| | Nd12 | 1.7725 | 1.7725 | 1.7725 |
| CONDITIONAL | Nd23/Nd22 | 1.07 | 1.05 | 1.07 |
| EXPRESSION (a) | | | | |
| CONDITIONAL | νd22 | 55.9 | 55.9 | 55.9 |
| EXPRESSION (b) | | | | |
| CONDITIONAL | νd23 | 23.9 | 27.0 | 23.9 |
| EXPRESSION (c) | | | | |
| CONDITIONAL | F22/F23 | −0.92 | −0.92 | −0.92 |
| EXPRESSION (d) | | | | |
| CONDITIONAL | FW/F23 | 0.44 | 0.54 | 0.40 |
| EXPRESSION (e) | | | | |
| CONDITIONAL | FW/F2 | −0.78 | −0.78 | −0.76 |
| EXPRESSION (f) | | | | |
| CONDITIONAL | D12/D11 | 2.70 | 2.80 | 2.74 |
| EXPRESSION (g) | | | | |
| CONDITIONAL | Nd12 | 1.7725 | 1.7725 | 1.7725 |
| EXPRESSION (h) | | | | |
| CONDITIONAL | (D11 + | 0.47 | 0.46 | 0.45 |
| EXPRESSION (i) | D12)/FW | | | |

### 4. Application Example

### Configuration of Imaging Apparatus

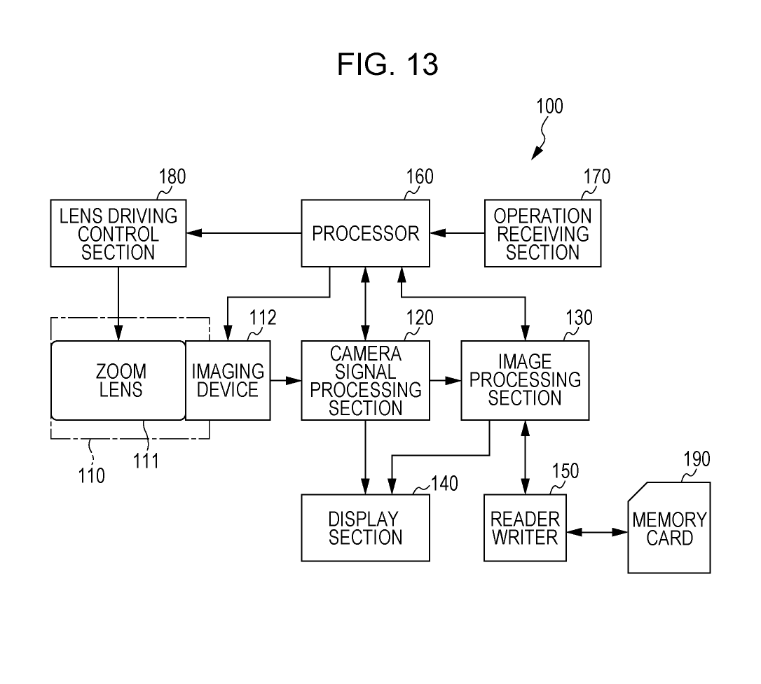

FIG. 13 is a diagram illustrating an example in which the zoom lens according to the first to third embodiments of the present technology is applied to an imaging apparatus 100. The imaging apparatus 100 includes a camera block 110, a camera signal processing section 120, an image processing section 130, a display section 140, a reader writer 150, a processor 160, an operation receiving section 170, and a lens driving control section 180.

The camera block 110 has a function of capturing an image, and includes a zoom lens 111 according to the first to third embodiments and an imaging device 112 that converts an optical image, which is formed by the zoom lens 111, into an electric signal. As the imaging device 112, for example, it is possible to use a photoelectric conversion element such as a charge coupled device (CCD) or a complementary metal-oxide semiconductor (CMOS). Regarding the zoom lens 111, here, the lens groups of the first to third embodiments are illustrated in simplified form as a single lens.

The camera signal processing section 120 performs signal processing such as analog-to-digital conversion processing on a captured image signal. The camera signal processing section 120 converts an output signal, which is output from the imaging device 112, into a digital signal. Further, the camera signal processing section 120 performs various signal processes such as noise removal, image quality correction, and conversion into luminance and chromatic difference signals.

The image processing section 130 performs a process of recording and reproducing the image signal. The image processing section 130 performs a process of coding for compression and decoding for decompression on an image signal based on a predetermined image data format, a process of conversion of data specification such as resolution, and the like.

The display section 140 displays the captured image and the like. The display section 140 has a function to display various kinds of data such as a condition of the operation performed through the operation receiving section 170 and a captured image. The display section 140 can be constituted by, for example, a liquid crystal display (LCD).

The reader writer 150 performs access for writing and reading the image signal on a memory card 190. The reader writer 150 writes image data, which is encoded by the image processing section 130, into the memory card 190 and additionally reads the image data which is recorded on the memory card 190. The memory card 190 is, for example, a semiconductor memory which is removable from the slot connected to the reader writer 150.

The processor 160 controls the entire imaging apparatus. The processor 160 functions as a control processing section to control all the circuit blocks within the imaging apparatus 100, and controls the circuit blocks on the basis of the operation instruction signals and the like from the operation receiving section 170.

The operation receiving section 170 receives an operation from a user. The operation receiving section 170 is realized by, for example, a shutter release button for performing a shutter operation, a selection switch for selecting operation modes, and the like. The operation instruction signal, which is received through the operation receiving section 170, is supplied to the processor 160.

The lens driving control section 180 controls driving of the lenses disposed in the camera block 110. The lens driving control section 180 controls a motor (not shown in the drawing) for driving the lenses of the zoom lens 111 on the basis of the control signal from the processor 160.

In the imaging apparatus 100, when the image capturing is in a standby state, an image signal of the image captured by the camera block 110 under the control of the processor 160 is output to the display section 140 through the camera signal processing section 120 so as to be displayed as a camera-through-image. Further, when the operation instruction signal for zooming is input from the operation receiving section 170, the processor 160 outputs a control signal to the lens driving control section 180, and moves predetermined lenses within the zoom lens 111 on the basis of the control of the lens driving control section 180.

When the operation receiving section 170 receives a shutter operation, the captured image signal is output from the camera signal processing section 120 to the image processing section 130, is encoded for compression, and is converted into digital data of the predetermined data format. The converted data is output to the reader writer 150 and is written in the memory card 190.

Focusing is performed, for example, in a case where the shutter release button of the operation receiving section 170 is pressed halfway or pressed fully for recording (photography). In this case, on the basis of the control signal received from the processor 160, the lens driving control section 180 moves the predetermined lenses of the zoom lens 111.

In a case of reproduction of image data recorded in the memory card 190, the reader writer 150 reads out predetermined image data from the memory card 190 in response to the operation which is received through the operation receiving section 170. Then, the readout image data is decoded for decompression by the image processing section 130, and subsequently the reproduced image signal is outputted to the display section 140, thereby displaying the reproduced image.

In addition, the embodiment has described the exemplary case where the imaging apparatus 100 according to the embodiment is applied to a digital camera, but the application range of the imaging apparatus 100 is not limited to the digital camera. For example, it may also be widely applied to camera sections and the like of digital input/output apparatuses such as a digital video camera, a mobile phone equipped with a camera, and a personal digital assistant (PDA) equipped with a camera.

As described above, according to the embodiment of the present technology, the negative lens L22 and the positive lens L23 of the second lens group GR2 of the zoom lens having four lens groups are made of the resin material, and the refractive index ratio is set in a predetermined range, whereby it is possible to reduce the weight of the zoom lens.

Further, the above-mentioned embodiment is just an example for realizing the present technology, and the items of the embodiments respectively correspond to specific items of claims of the disclosure. Likewise, the specific items of the claims of the disclosure respectively correspond to the items of the embodiments of the present technology represented by the same names. However, the present technology is not limited to the embodiments, and may be embodied through various modifications of the embodiments without departing from the scope thereof.

In addition, the present technology may have the following configurations.

(1) There is provided a zoom lens including, in order from the object side: a first lens group having a positive refractive power; a second lens group having a negative refractive power; a third lens group having a positive refractive power; and a fourth lens group having a positive refractive power.

The second lens group includes, in order from the object side, a negative meniscus lens concave toward the image plane side, a negative lens concave toward both sides, and a positive lens convex toward both sides.

The negative lens and the positive lens of the second lens group are made of a resin material, and satisfy the following Conditional Expression (a). Conditional Expression (a): 1.02<Nd23/Nd22<1.10, where Nd22 is a d-line refractive index of the negative lens of the second lens group, and Nd23 is a d-line refractive index of the positive lens of the second lens group.

(2) The zoom lens according to (1) satisfies the following Conditional Expressions (b) and (c). Conditional Expression (b): 52<νd22<60, and Conditional Expression (c): 20<νd23<31, where νd22 is an Abbe number of the negative lens of the second lens group, and νd23 is an Abbe number of the positive lens of the second lens group.

(3) In the zoom lens according to (1) or (2), during power variation from a wide-angle end to a telephoto end, each group moves to increase spacing between the first lens group and the second lens group and decrease spacing between the second lens group and the third lens group.

(4) The zoom lens according to any one of (1) to (3) satisfies the following Conditional Expression (d). Conditional Expression (d): −1.08<F22/F23<−0.82, where F22 is a focal length of the negative lens of the second lens group and F23 is a focal length of the positive lens of the second lens group.

(5) The zoom lens according to any one of (1) to (4) satisfies the following Conditional Expression (e). Conditional Expression (e): 0.34<FW/F23<0.60, where F23 is a focal length of the positive lens of the second lens group, and FW is a focal length of the zoom lens at the wide-angle end.

(6) The zoom lens according to any one of (1) to (5) satisfies the following Conditional Expression (f). Conditional Expression (f): −0.88<FW/F2<−0.66, where FW is a focal length of the zoom lens at the wide-angle end, and F2 is a focal length of the second lens group.

(7) In the zoom lens according to any one of (1) to (6), at least one surface of the negative lens of the second lens group is aspheric.

(8) In the zoom lens according to any one of (1) to (7), at least one surface of the positive lens of the second lens group is aspheric.

(9) In the zoom lens according to any one of (1) to (8), the first lens group includes a cemented lens formed of a negative meniscus lens convex toward the object side and a positive meniscus lens convex toward the object side, and satisfies the following Conditional Expressions (g), (h), and (i). Conditional Expression (g): 2.5<D12/D11<3.1, Conditional Expression (h): 1.72<Nd12<1.82, and Conditional Expression (i): 0.41<(D11+D12)/FW<0.51, where D11 is an on-axis center thickness of the negative meniscus lens of the first lens group, D12 is an on-axis center thickness of the positive meniscus lens of the first lens group, and Nd12 is a d-line refractive index of the positive meniscus lens of the first lens group.

(10) There is provided an imaging apparatus including: a zoom lens; and an imaging device that converts an optical image, which is formed by the zoom lens, into an electric signal. The zoom lens includes, in order from the object side, a first lens group having a positive refractive power, a second lens group having a negative refractive power, a third lens group having a positive refractive power, and a fourth lens group having a positive refractive power. The second lens group includes, in order from the object side, a negative meniscus lens concave toward the image plane side, a negative lens concave toward both sides, and a positive lens convex toward both sides. The negative lens and the positive lens of the second lens group are made of a resin material, and satisfy the following Conditional Expression (a). Conditional Expression (a): 1.02<Nd23/Nd22<1.10, where Nd22 is a d-line refractive index of the negative lens of the second lens group, and Nd23 is a d-line refractive index of the positive lens of the second lens group.

It should be understood by those skilled in the art that various modifications, combinations, sub-combinations and alterations may occur depending on design requirements and other factors insofar as they are within the scope of the appended claims or the equivalents thereof.

What is claimed is:

1. A zoom lens comprising, in order from an object side:
a first lens group having a positive refractive power;
a second lens group having a negative refractive power;
a third lens group having a positive refractive power; and
a fourth lens group having a positive refractive power,
wherein the second lens group includes, in order from an object side, a negative meniscus lens concave toward an image plane side, a negative lens concave toward both sides, and a positive lens convex toward both sides, and
wherein the negative lens and the positive lens of the second lens group are made of a resin material, and satisfy the following Conditional Expression (a).
1.02<Nd23/Nd22<1.10, Conditional Expression (a):
where
Nd22 is a d-line refractive index of the negative lens of the second lens group, and
Nd23 is a d-line refractive index of the positive lens of the second lens group.

2. The zoom lens according to claim 1, wherein the following Conditional Expressions (b) and (c) are satisfied.
52<vd22<60, Conditional Expression (b):
and
20<νd23<31, Conditional Expression (c):
where
νd22 is an Abbe number of the negative lens of the second lens group, and
νd23 is an Abbe number of the positive lens of the second lens group.

3. The zoom lens according to claim 1, wherein during power variation from a wide-angle end to a telephoto end, each group moves to increase spacing between the first lens group and the second lens group and decrease spacing between the second lens group and the third lens group.

4. The zoom lens according to claim 1, wherein the following Conditional Expression (d) is satisfied.
−1.08<F22/F23<−0.82, Conditional Expression (d):
where
F22 is a focal length of the negative lens of the second lens group, and
F23 is a focal length of the positive lens of the second lens group.

5. The zoom lens according to claim 1, wherein the following Conditional Expression (e) is satisfied.
0.34<FW/F23<0.60, Conditional Expression (e):
where
F23 is a focal length of the positive lens of the second lens group, and
FW is a focal length of the zoom lens at a wide-angle end.

6. The zoom lens according to claim 1, wherein the following Conditional Expression (f) is satisfied.
−0.88<FW/F2<−0.66, Conditional Expression (f):
where
FW is a focal length of the zoom lens at a wide-angle end, and
F2 is a focal length of the second lens group.

7. The zoom lens according to claim 1, wherein at least one surface of the negative lens of the second lens group is aspheric.

8. The zoom lens according to claim 1, wherein at least one surface of the positive lens of the second lens group is aspheric.

9. The zoom lens according to claim 1, wherein the first lens group includes a cemented lens formed of a negative meniscus lens convex toward the object side and a positive meniscus lens convex toward the object side, and satisfies the following Conditional Expressions (g), (h), and (i).
2.5<D12/D11<3.1, Conditional Expression (g):
1.72<Nd12<1.82, Conditional Expression (h):
and
0.41<(D11+D12)/FW<0.51, Conditional Expression (i):
where
D11 is an on-axis center thickness of the negative meniscus lens of the first lens group,
D12 is an on-axis center thickness of the positive meniscus lens of the first lens group, and
Nd12 is a d-line refractive index of the positive meniscus lens of the first lens group.

10. An imaging apparatus comprising:
a zoom lens; and
an imaging device that converts an optical image, which is formed by the zoom lens, into an electric signal,
wherein the zoom lens includes, in order from an object side,
a first lens group having a positive refractive power,
a second lens group having a negative refractive power,
a third lens group having a positive refractive power, and
a fourth lens group having a positive refractive power,
wherein the second lens group includes, in order from an object side, a negative meniscus lens concave toward an image plane side, a negative lens concave toward both sides, and a positive lens convex toward both sides, and
wherein the negative lens and the positive lens of the second lens group are made of a resin material, and satisfy the following Conditional Expression (a).
1.02<Nd23/Nd22<1.10, Conditional Expression (a):
where
Nd22 is a d-line refractive index of the negative lens of the second lens group, and
Nd23 is a d-line refractive index of the positive lens of the second lens group.
